(19) United States
(12) Patent Application Publication
(10) Pub. No.: US 2023/0085663 A1
(43) Pub. Date: Mar. 23, 2023

(54) Method for Analyzing a Structure within a Fluidic System

(71) Applicant: Robert Bosch Gesellschaft Mit Beschränkter Haftung, Stuttgart (DE)

(72) Inventor: Anna-Lina Hahn, Tuebingen (DE)

(21) Appl. No.: 17/802,010

(22) PCT Filed: Feb. 26, 2021
(86) PCT No.: PCT/DE2021/100196

§ 371 Date: Aug. 24, 2022

(30) Foreign Application Priority Data
Feb. 27, 2020 (DE) 10 2020 202 528.2

(51) Int. Cl. G06V 20/69

(52) U.S. Cl. CPC G06V 20/695; G06V 20/698

(57) ABSTRACT

A reference image and at least one object image and at least one analysis image are used in a method for analyzing a structure within a fluidic system. A reference image section with the structure to be analyzed, which is isolated from a reference image, is provided, the reference image having been recorded with a first camera setting. An object image which has the same fluidic state as the reference image and which was recorded with the first or a second camera setting is selected. Using the object image and using the reference image section, an image registration is performed and an edge recognition is applied for the purposes of creating a mask. At least one analysis image is selected beforehand or afterwards, the at least one analysis image and the object image having been recorded with the same camera setting. The mask is applied to the analysis image for the purposes of isolating the image section of the analysis image to be analyzed. Subsequently, the image section to be analyzed can be examined using an image-analytical evaluation.

The present invention relates to a method for analyzing a structure within a fluidic system using image-analytic methods.

### PRIOR ART

Using image-analytic methods in the evaluation and control of processes in microfluidic devices is known. Thus, for example, the fill level of a microfluidic device or the presence of bubbles within a microfluidic device can be examined. For example, WO 2005/011947 A2 describes a method for processing an image of a microfluidic device, wherein a first image of the microfluidic device in a first state and a second image of the microfluidic device in a second state are obtained. The first image and the second image are transformed in a third coordinate space, wherein a difference between the first image and the second image is ascertained. Crystals in individual chambers of the microfluidic device can be detected using this method. U.S. Pat. No. 8,849,037 B2 also describes a method for image processing for microfluidic devices, in which multiple images are analyzed by a dynamic comparison. By employing a baseline correction, bubbles can be recognized using this method.

The method of edge detection is known from image processing. Edge detection is not only used for closed structures, however, but also for those structures which have continuous edges. Non-closed structures, for example, a channel detail of a microfluidic device or a chamber having supply and drain, are not analyzable using conventional edge detection. Analysis of such non-closed structures therefore generally requires an examination of multiple, sequentially recorded images, wherein differences can be recognized by a dynamic comparison of the images.

### SUMMARY OF THE INVENTION

### Advantages of the Invention

The invention provides a method for analyzing a structure within a fluidic system, in which both closed structures and also, particularly advantageously, open structures can be examined using image processing methods. Edge detection is applied for this purpose. As already mentioned, open structures are not accessible to edge detection for the mentioned reasons. The proposed method permits the application of edge detection to open structures as well, however, so that the method is usable for various fluidic systems, in which open structures are often to be evaluated, for example, channel details or chambers having supplies and/or drains. The proposed method uses a reference image and at least one object image and at least one analysis image, wherein the latter is evaluated using the proposed method. This evaluation can take place, for example, with regard to bubble detection or a different evaluation of a fluidic system.

The method first provides a provision of a reference image detail having the structure to be analyzed (step a.), wherein the structure to be analyzed is isolated from a reference image. The reference image was recorded using a first camera setting. For this purpose, isolation and storage of the reference image detail having the structure to be analyzed from the reference image, which was recorded using a first camera setting, may be performed. It is also possible that a reference image detail which was already isolated earlier is used. Furthermore, an object image (default image) is selected, which has the same fluidic state as the reference image and which was recorded using the first camera setting or a different, a second camera setting (step b.). According to the proposed method, an image registration of the object image with the reference image detail is carried out (step c.). The image registration, also called co-registration, is a method known per se of digital image processing, in which two or more images are fused or superimposed with one another. This involves bringing two or more images of the same or at least a similar scene into correspondence with one another in the best possible manner. In general, an equalizing transformation is calculated for the adaptation of the images to one another, in order to bring the one image into correspondence with the other image in the best possible manner. This method is often used in medical image processing, for example. The proposed method uses the image registration to fuse the object image with the reference image detail, which can have been recorded using different camera settings and at different times, and further process them. Edge detection is applied to the fused image to create a mask on this basis. In this way, the image registration also permits the analysis of a non-closed structure in a fluidic system and in particular in a microfluidic device. The central point here is that an isolation of the structure to be analyzed is possible by way of the image registration and the application of the edge detection, so that it is transferred from a possibly non-closed state into a closed state. The mask created on the basis of the image registration is applied to the analysis image, so that the image detail of the analysis image to be analyzed can he isolated on the analysis image (step e.). The analysis image or images to be examined can have been selected beforehand or during the course of the method (step d.). For this purpose, the at least one analysis image is to have been recorded using the same camera setting as the object image. The image detail to be analyzed, which is isolated from the analysis image with the aid of the mask, can subsequently be examined by means of an image-analytic evaluation (step f.), for example, with regard to a proportion of bubbles or the like. This evaluation can be carried out in particular on the basis of a determination of pixel intensities, so that, for example, a percentage proportion of bubbles within a chamber of a microfluidic device can be determined at the time t1 and t2. For example, it can hereby be established that the chamber was filled 50% with bubbles at the time t1 and 20% at the time t2.

The structure to be examined can in principle have any conceivable shape, for example, a rectangle, a circle, an arbitrary polygon, or the like. This structure represents, for example, a specific chamber within a microfluidic device or a specific detail from a channel of a microfluidic device or the like. The special advantage of the invention is that non-closed structures, for example, a detail from a channel, which does not have completely continuous edges, can be analyzed using the proposed method. In this method, a non-closed structure is isolated once in such a way that it is converted into a closed structure. This is carried out in particular in the scope of the isolation and storage of a reference image detail having the structure to be analyzed from the reference image according to step a. Specific specifications can be used for this isolation, so that this isolation can be carried out on a computer basis. Furthermore, a manual isolation of the reference image detail is also possible. By way of the steps of the proposed method, this previously produced closed structure is transferred to the actually not closed structure to be studied, so that the described image-analytic evaluation is made possible. In this way, for example, the determination of various parameters of the non-closed structure becomes possible, for example, various two-dimensional dimensions, fillings, or other things can be determined without close image recordings and a dynamic comparison of the image data being necessary. In particular, the proposed method permits bubble detection, for example, on the basis of a determination of threshold values and a percentage evaluation of pixel numbers which are above or below a predefinable threshold value, respectively. Such an image-analytic evaluation is to be carried out significantly faster and more easily than, for example, a complete comparison of the intensities of two or more images.

In one advantageous embodiment of the proposed method, before the image registration, image processing can be carried out on the object image for equalization to the reference image detail. For example, the object image can be rotated appropriately in adaptation to the reference image detail, so that a correspondence with the reference image detail is provided. Further possible image processing steps are, for example, a conversion of colors into grayscales and/or a smoothing of the image and/or the application of edge detection. Furthermore, for example, a filling of a closed structure and/or a removal of specific elements of the structure and/or a calculation of the circumference and/or a calculation of other parameters of the structure can be carried out. Whether and which such optional steps are reasonable and/or advantageous is dependent on the respective object image. In general, the following image registration can be optimized by such image-processing steps.

Further image processing can also be carried out for the creation of the mask after the image registration, for example, a conversion of colors into grayscales and/or a smoothing of the image. Furthermore, for example, the filling of a closed structure and/or a removal of specific elements of the structure and/or an extraction of edges and/or a calculation of the circumference and/or other parameters of the structure are possible in the scope of such image processing. In a particularly advantageous manner, for example, the complete background of the structure can be set to one color tone, for example white. Furthermore, artifacts at the image edge, if present, can be eliminated in order to further clean up the boundaries of the structure. Furthermore, the structure can be completely filled to eliminate edges within the structure. By applying such measures in conjunction with the edge detection, which can also be optimized by further image processing, for example, by thickening to avoid edge gaps or by eliminating artifacts, as a whole the closed edge of the structure to be analyzed can be extracted as the mask. This mask can be filled, for example, in dependence on the image-analytic evaluation to be carried out later, for example, to simplify a later analysis by means of a histogram.

In a preferred manner, one or more image processing steps are also carried out on the at least one analysis image, so that the analysis image can be equalized to the object image before the image registration. For example, this image processing step can comprise a rotation of the image, so that the position of the structure to be analyzed, for example, the position of a chamber within the microfluidic device, corresponds to the object image. A conversion of the colors of the analysis image into grayscales is particularly preferred, in order to facilitate the later evaluation, for example, on the basis of a pixel distribution. Cutting out the relevant image detail can also be advantageous. This measure also facilitates the later evaluation.

In a particularly preferred manner, the subsequent evaluation or the examination of the image detail to be analyzed is carried out by means of a threshold value method, preferably the evaluation can be carried out in this case on the basis of a frequency distribution of pixels, in particular pixels, the intensities of which are above or below a predefinable threshold value.

Using the proposed method, in this manner a detection of bubbles within a microfluidic device as a fluidic system can be performed in a particularly advantageous manner, for example, the detection of bubbles within a specific chamber or a specific reaction space or a specific channel section of a microfluidic device. However, the method is not restricted to such applications. The method can also be used to determine other parameters of a fluidic system. In principle, the proposed method can be used for a variety of fluidic systems, for example, with regard to monitoring or control of manufacturing methods and/or for quality controls of fluidic and in particular microfluidic systems, for example, to determine the size and location of solids, for example, of crystals, within the system. Another parameter which can be examined using the proposed method is, for example, the escape of liquid from the system into the surroundings, wherein this escape can make itself noticeable by intensity changes which are detectable using the proposed method.

Further features and advantages of the invention result from the following description of exemplary embodiments in conjunction with the drawings. The individual features can each be implemented as such or in combination with one another.

In the figures of the drawings:

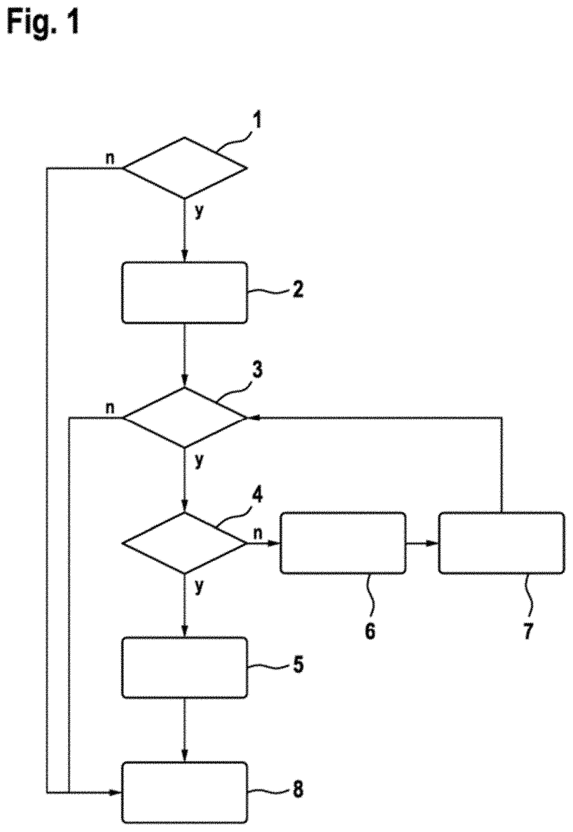

FIG. 1 shows a flow chart of an algorithm for carrying out the proposed method and

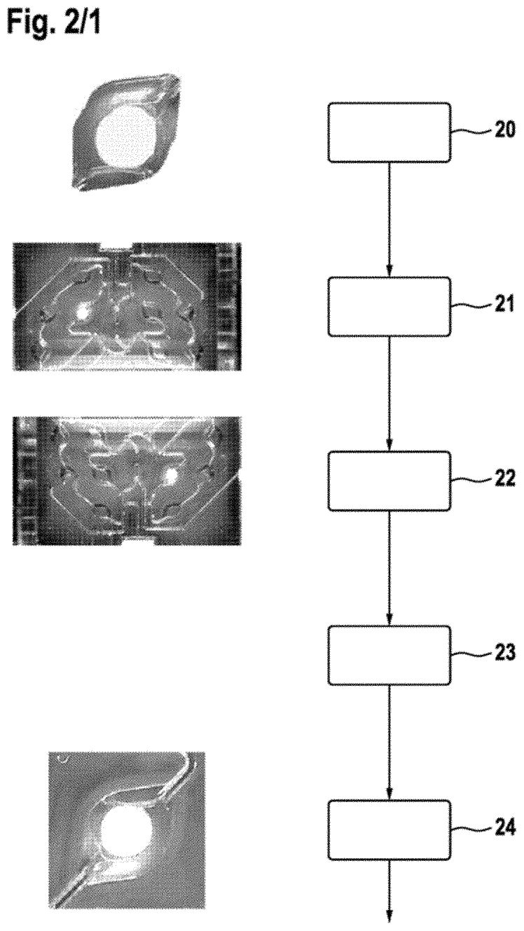

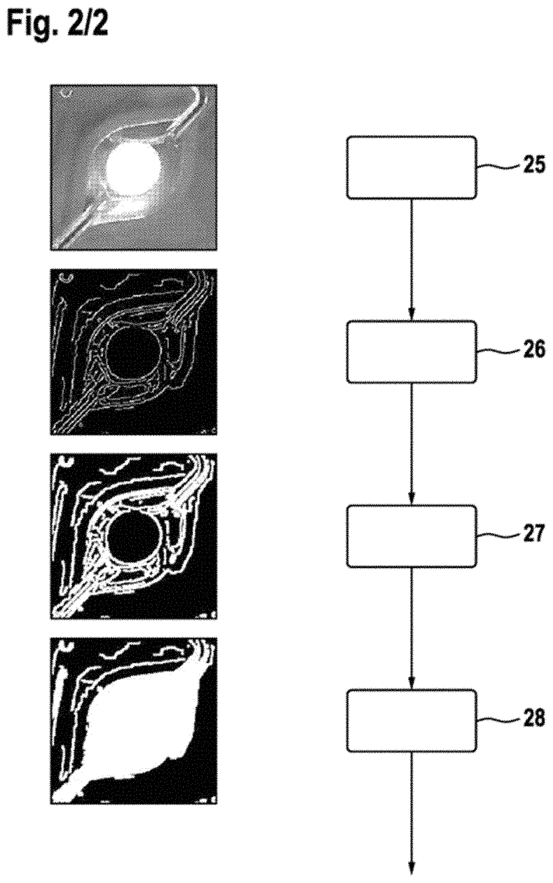

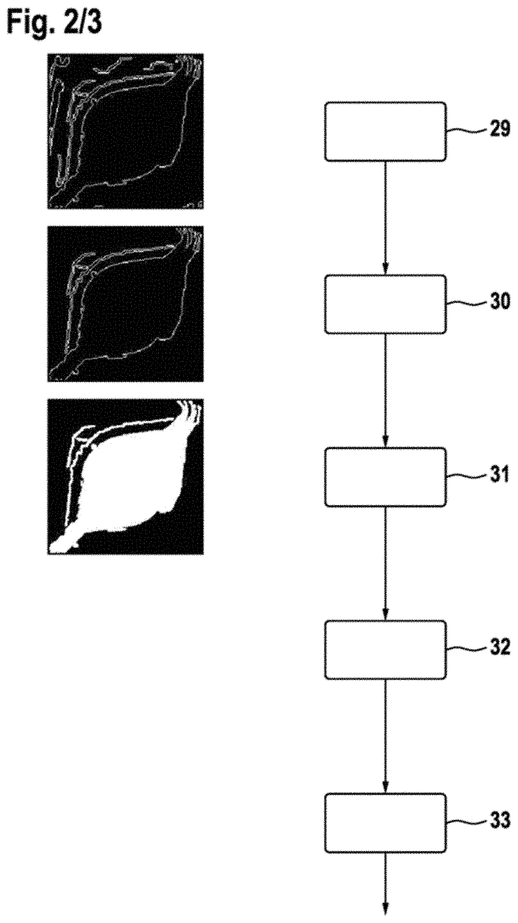

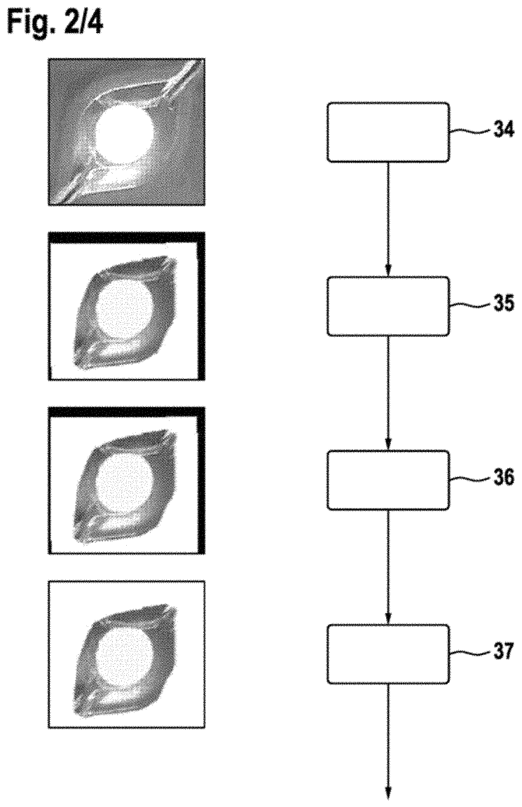

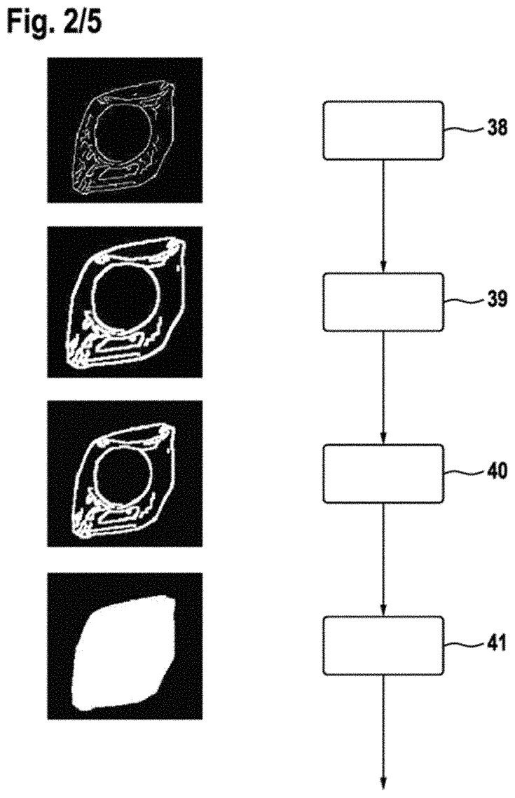

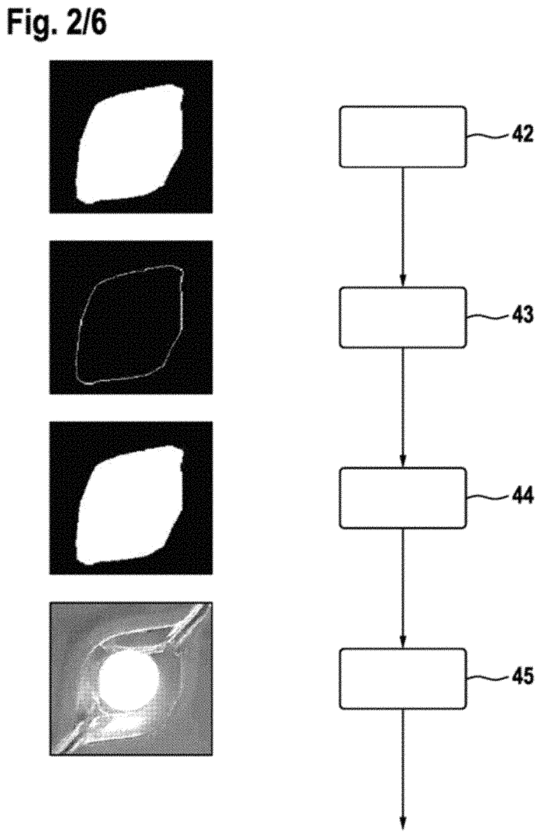

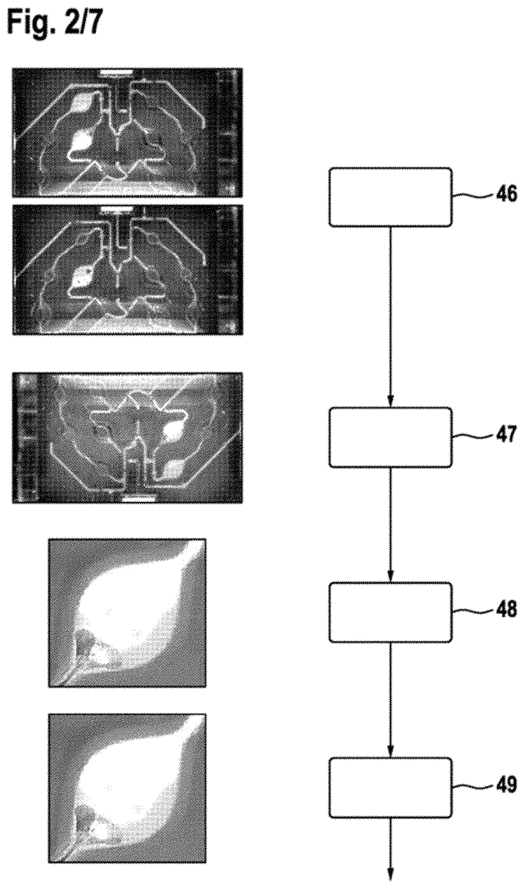

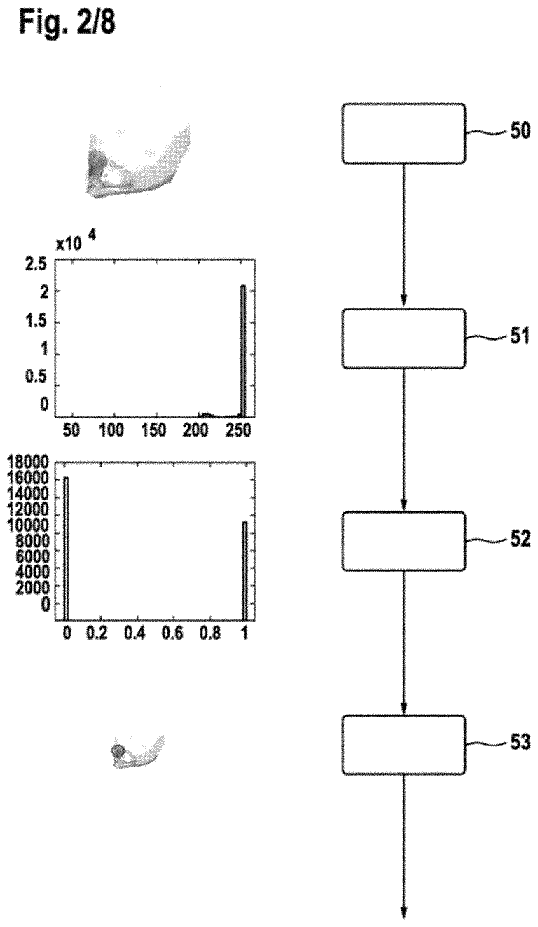

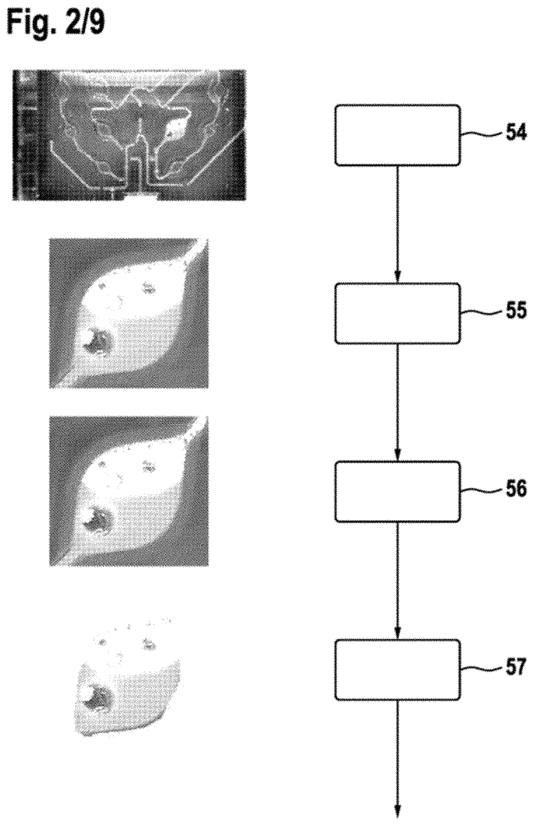

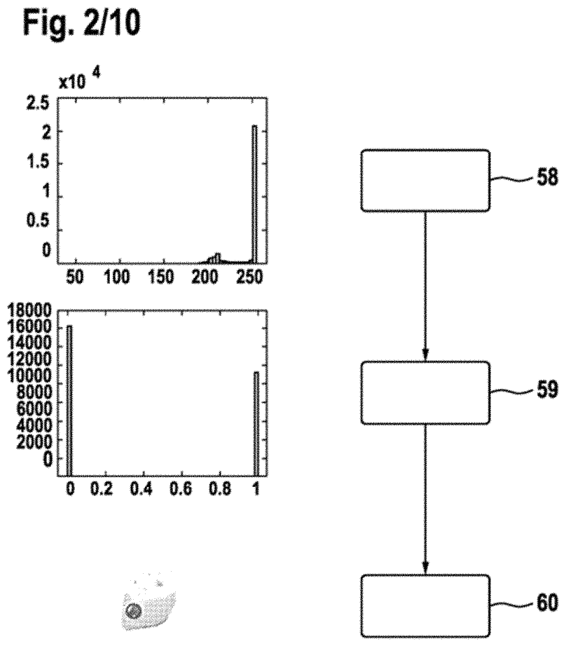

FIG. 2 shows an illustration of various steps of the proposed method, partially on the basis of image details (FIGS. 2/1-2/10).

### DESCRIPTION OF EXEMPLARY EMBODIMENTS

FIG. 1 illustrates various steps of the proposed method in the form of an algorithm. In step 1, the query first takes place as to whether an object image (default image) was selected. If this is the case, in step 2, the initial preparation of the object image takes place, possibly with image processing and the image registration of the object image with the previously isolated and stored reference image detail having the structure to be analyzed to create a mask. Subsequently, it is queried in step 3 whether one or more analysis images were selected. If this is the case, in step 4, the query takes place as to whether only one analysis image was selected. If this is the case, in step 5, the further analysis of the analysis image is carried out by applying the created mask to the analysis image and the further image-analytic analysis is carried out to evaluate the image detail to be analyzed. If the query in step 4 has the result that more than one analysis image was selected, in step 6, one image is selected and analyzed comparably with step 5. Subsequently, in step 7, the number of the analysis images may be reduced by one and the sequence can jump back to step 3, so that the various images can be analyzed according to steps 5 and/or in succession. If all analysis images are evaluated, the program can be ended in step 8. Thus if no more analysis images to be analyzed are selected, the sequence jumps from step 3 directly to the end of the program in step 8. If the query results in step 1 that no object image was selected, the sequence can also jump directly to the program end in step 8. This method thus provides a loop for processing multiple selected analysis images. If more than one image (for example ten images) were selected in step 4, one image thereof is taken and this image is analyzed. The new number of the images is then calculated (now nine). The loop is thus executed a total of nine times. Only one image then remains. This is analyzed last and the program is ended. If only one image was selected from the beginning, the loop can be ignored.

FIG. 2 illustrates various possible steps of the proposed method, partially on the basis of image details (partial FIGS. 2/1 to 2/10). In step 20, first the structure to be analyzed is cut out once from an image of the fluidic system (reference image) and is stored as a new image having white background. This reference image detail can be used for a large number of performances of the method described hereinafter. In step 21, an object image (default image) is selected, which displays the same fluidic status as the reference image. In this example, for example, this is a chamber of the microfluidic device not filled with liquid, which is represented by a white circle. The white circle can be caused here by a solid which was introduced into the microfluidic device and which will be dissolved in the following operation of the microfluidic device. Even if the object image and the reference image show the same fluidic status, the camera settings, for example, orientation, zoom, or others, can deviate from one another. If no such object image is selected, the program can be ended, as was already explained on the basis of FIG. 1. In the next or in a following step, in principle arbitrarily many images can be selected which are to be analyzed (analysis images). This selection of the analysis images can take place now or at a later time, however, the object image and the analysis images should have been recorded using the same camera setting.

The object image obtained in step 21 can be rotated, for example, by 180° optional step 22 to facilitate the later image registration (image fusion) with the reference image detail.

In the following steps, for simplified processing of the images, the structure to be analyzed can also be cut out or isolated from the object image. This can be carried out on the basis of a detection of the white circle in step 23 and a definition of a frame around the corresponding image detail (step 24). Following image processing steps 25 to 34 are also optional and can be carried out for simplification and optimization of the subsequent image registration in step 35. These image processing steps of the object Image can comprise a conversion of the colors of the image into grayscales (step 25). Furthermore, edge detection can be applied to the image in step 26. In step 27, thickening of the edges can be carried out. In step 28, filling up of the area between the connected edges can take place. In step 29, a determination of various parameters of the image can take place, for example, a determination of the circumference. In step 30, a removal of all pixels can take place which are associated with a region having fewer than, for example, 400 connected pixels, so that the representation is cleaned up further. In step 31, filling of the outline can take place. In step 32, a calculation of the parameters of the filled structure can take place to find the position and the size of the circle in the object image. In step 33, for example, the first and the last white pixels in the x and y directions can be ascertained to be able to find and isolate the image detail in dependence on the chamber position. In step 34, an isolation of the image detail can take place in dependence on the chamber position to avoid variances which result from the position of the circle in the object image.

These various optional steps can be used to improve the subsequent image registration in step 35. For example, the edge detection can be used to obtain a black-and-white representation of the chamber and to find the chamber accordingly within the image. This can be reasonable, for example, if a possibly existing solid in the chamber is located at an extreme position within the chamber and this is not completely present in the image, for example, since a part is cut off. If the solid is located on the very left in the chamber, for example, and the image is isolated or cut on the basis of the solid in the chamber, it can occur that the chamber is not completely acquired. The isolation and cutting out of the chamber as such is generally not possible due to the different background and the open structure. Moreover, the problem would exist that the chamber would not be cut out correctly with (slightly) different zoom settings. In other cases, it is entirely possible that these optional steps and the isolation and cutting out can be omitted.

In general, using these optional steps, the size of the structure to be analyzed can be obtained and possibly further parameters can be determined. These image processing steps are only to be understood as examples, however, and can in general improve the following image registration in step 35. Which steps are reasonable is dependent in particular on the respective object image, however, wherein the following image registration can be optimized by this image processing.

In subsequent step 35, the image registration is carried out, in which the object image processed in this case and the reference image detail are fused with one another. Subsequently, in step 36, the colors can optionally be converted into grayscales. In step 37, the complete background can be set to one color tone, for example to white, or the black edges at the edge of the fused image detail can be removed. Subsequently, in step 38, edge detection is applied to the fused image. The edges can be thickened in step 39 to avoid edge gaps at the edge of the structure. In this example, for example, a threefold thickening is shown. In step 40, artifacts at the image edge can be eliminated, if present. The boundaries of the structure can be cleaned up further thereby. In step 41, in this example the structure is completely filled to eliminate edges within the structure. Subsequently, in step 42, smoothing of the image can take place.

After these optional steps, in step 43, the peripheral edge of the structure is extracted to generate the mask. In particular in dependence on following analysis steps, the mask can be filled in step 44. This can be expedient in particular with regard to a later analysis by means of a histogram.

After this preparation of the object image and its fusion with the reference image detail and the creation of the mask, the analysis image or images are used in step 46. This corresponds to step 3 in FIG. 1. If multiple analysis images are provided, these can be processed individually in succession. The analysis images show, for example, a microfluidic device in different fluidic states which can deviate from the fluidic state of the object image. The edge of the mask from step 43 can initially be applied beforehand to the analysis image in step 45, for example, to carry out a visual check.

The analysis image to be examined can be rotated in step 47, for example, by 180°, so that it corresponds to the object image in the state before the image registration. In step 48, the image detail can be cut out which corresponds to the chamber position or the position of the structure to be analyzed from the object image. In step 49, a conversion of the colors into grayscales can take place. In step 50, the previously created mask is applied or attached to this detail of the analysis image. The corresponding image can thus be cut out and the structure can be isolated from the background, so that a previously non-closed structure is converted into a closed structure. Subsequently, in step 51, in this evaluation example a histogram is generated which represents the number of the pixels having a specific intensity of the masked image. This histogram thus represents the masked analysis image. In step 52, a comparison histogram can be generated which represents the proportion of the white and the black pixels of the mask, thus the mask from step 44. The histogram of the masked analysis image differs from the comparison histogram primarily in the background and possibly in the number of the pixels. From the comparison of the histograms from steps 51 and 52, which do not necessarily have to be created in the illustrated sequence, an evaluation can be performed, for example, with regard to the presence of bubbles within the structure. Specifically, for this purpose a histogram of the closed structure is created by the application of the mask to the analysis image (step 51) and a histogram of the filled mask (step 52) is created. The number of the white pixels of the filled mask corresponds to the total number of the pixels. A threshold value method is carried out for the closed structure. For this purpose, pixels below a defined value are counted and the pixels above this defined value are ignored. This evaluation or counting of the pixels can also take place in the reverse manner. By means of a rule of three calculation, for example, the percentage proportion of the pixels which were ascertained by this threshold value method within the chamber or the examined structure can be determined. In the example shown here, for example, black pixels or very dark gray pixels are assessed as bubbles, so that the percentage filling of the chamber or the percentage proportion of the bubbles in the chamber can be calculated using this method. In an additional or alternative evaluation in step 53, bubbles can be determined via the recognition of circles.

Following steps 54 to 60 illustrate the corresponding processing and evaluation of the further analysis image from step 46, wherein steps 54 to 60 correspond to steps 47 to 53.

The reference image or the reference image detail can be used for various object images having the same fluidic status, which were recorded, for example, at an earlier or later time. It is particularly advantageous in this case that the different object images can have been recorded using different settings, in particular zoom, detail, orientation, or others. This particularly advantageously enables an automated analysis of images at various times having the same fluidic status.

In principle, it is possible that the object image and the analysis image are the same image. However, in this case, in contrast to the example shown, the analysis image which is also used as the object image is not to display excessively strong bubble formation, so that problems do not occur in the image registration between object image and reference image detail.

1. A method for analyzing a structure within a fluidic system using a reference image and at least one object image and at least one analysis image, comprising:
(a) providing a reference image detail having the structure to be analyzed, which is isolated from a reference image, wherein the reference image was recorded using a first camera setting,
(b) selecting an object image, which has the same fluidic state as the reference image and which was recorded using the first camera setting or a second camera setting,
(c) carrying out an image registration of the object image with the reference image detail and applying edge detection to create a mask,
(d) selecting at least one analysis image, wherein the at least one analysis image and the object image were recorded using the same camera setting,
(e) applying the mask to the analysis image to isolate the image detail of the analysis image to be analyzed, and
(f) examining the image detail to be analyzed by way of an image-analytic evaluation.

2. The method as claimed in claim 1, wherein, before step (c) is performed, carrying out image processing on the object image for equalization to the reference image detail.

3. The method as claimed in claim 2, wherein the image processing comprises conversion of colors into grayscales and/or smoothing of the image and/or application of edge detection.

4. The method as claimed in claim 2, wherein the image processing comprises filling a closed structure and/or removal of specific elements of the structure and/or calculation of the circumference and/or other parameters of the structure.

5. The method as claimed in claim 1, wherein image processing is carried out to create the mask.

6. The method as claimed in claim 5, wherein the image processing comprises conversion of colors into grayscales and/or smoothing of the image.

7. The method as claimed in claim 5, wherein the image processing comprises filling a closed structure and/or removal of specific elements of the structure and/or extraction of edges and/or calculation of the circumference and/or other parameters of the structure.

8. The method as claimed in claim 1, wherein at least one image processing step is carried out on the at least one analysis image for equalization of the analysis image to the object image before the image registration.

9. The method as claimed in claim 1, wherein before the application of the mask to the at least one analysis image, the colors of the analysis image are converted into grayscales.

10. The method as claimed in claim 1, wherein the examination of the image detail to be analyzed is carried out by way of a threshold value method.

11. The method as claimed in claim 10, wherein the evaluation is carried out on the basis of frequency distributions of pixels.

12. The method as claimed in claim 1, wherein the analysis of the structure comprises detection of bubbles within a microfluidic device as the fluidic system.
